(19) United States
(12) Patent Application Publication
(10) Pub. No.: US 2026/0360899 A1
(43) Pub. Date: Nov. 12, 2026

(54) Electrical Energy Store for a Motor Vehicle, in Particular for an Automobile, and Motor Vehicle

(71) Applicant: Bayerische Motoren Werke Aktiengesellschaft, Muenchen (DE)

(72) Inventors: Andreas GERNER, Unterhaching (DE); Rafael OPELA, Karlsfeld (DE); Marcel RUECK, Langenau (DE); Philipp SCHLAG, Groebenzell (DE); Martin SPAETH, Muenchen (DE)

(21) Appl. No.: 19/120,820

(22) PCT Filed: Nov. 29, 2023
(86) PCT No.: PCT/EP2023/083504

§ 371 Date: Apr. 14, 2025

(30) Foreign Application Priority Data
Dec. 7, 2022 (DE) 10 2022 132 439.7

(51) Int. Cl. H01M 50/249; H01M 50/204; H01M 50/262; H01M 50/524

(52) U.S. Cl. CPC H01M 50/249; H01M 50/204; H01M 50/262; H01M 50/524; H01M 2220/20

(57) ABSTRACT

An electrical energy store for a motor vehicle, having at least two storage modules which each have a plurality of electrically interconnected storage cells for storing electrical energy and are arranged in a circuit having at least one first line element, via which circuit the storage modules are electrically interconnected, and having at least one second line element formed separately from the first line element, wherein the first line element is connected to the second line element by at least one connecting element formed separately from the line elements, said connecting element being interlocked with the second line element and thereby attached to the second line element.

### BACKGROUND AND SUMMARY

The invention relates to an electrical energy store for a motor vehicle, in particular for an automobile, according to the present disclosure. The invention also relates to a motor vehicle with at least one such electrical energy store.

DE 10 2021 106 470 A1 is an electrical energy store for storing electrical energy for a motor vehicle. Furthermore, DE 10 2010 002 681 B4 discloses an electrical connector. Furthermore, from DE 10 2017 206 283 A1 a cell module is known for a high-voltage energy store of a motor vehicle.

An object of the present invention is to create an electrical energy store for a motor vehicle as well as a motor vehicle with such an electrical energy store, so that a particularly simple and thus time-and cost-effective production of the electrical energy store can be realized.

According to the invention, this object is achieved by an electrical energy store with the features disclosed herein, and by a motor vehicle with the features disclosed herein. Advantageous embodiments of the invention are also the subject matter of the present disclosure.

A first aspect of the invention relates to an electrical energy store for a motor vehicle also simply referred to as an automobile and preferably in the form of a car, in particular a passenger car. This means that the motor vehicle in its fully manufactured state has the electrical energy store by which or in which electrical energy is to be stored or is stored, in particular electrochemically. Preferably, the electrical energy store is a high-voltage component wherein the electrical voltage thereof, in particular the electrical operating voltage or nominal voltage, is preferably greater than 50 volts, in particular greater than 60 volts, and is most preferably several hundred volts. For example, the motor vehicle is a hybrid vehicle or an electric vehicle, in particular a battery electric vehicle (BEV). For example, the motor vehicle in its fully manufactured state has at least one electric machine by which the motor vehicle can be electrically driven, especially solely. For example, the electric machine can be supplied with the electrical energy stored in the electrical energy store, which means that the electric machine can be operated in a motor mode and thus as an electric motor. The motor vehicle can be electrically driven by the electric motor, especially solely. Preferably, the electric machine is a high-voltage component, wherein the electrical voltage thereof, in particular the operating or nominal electrical voltage, is preferably greater than 50 volts, and in particular greater than 60 volts, and is most preferably several hundred volts. In particular, the electrical energy store is a battery, especially a high-voltage battery, wherein the electrical energy store is particularly preferably a secondary battery.

The electrical energy store has at least two storage modules, which are simply referred to as modules. The respective storage module has several separately formed storage cells for storing electrical energy, especially electrochemically. The storage cells of the modules are also referred to as cells and are individual cells, i.e. separately formed, individual components. The storage cells of the respective storage module are electrically connected to each other. In addition, the storage modules are electrically connected to each other. For this purpose, the storage modules are arranged in an electrical circuit that has at least one first line element. The first line element is also referred to as a module connector because the storage modules in particular are electrically connected to each other by the module connector. It is also conceivable that one of the storage modules is electrically connected to a battery management unit (BMU) of the electrical energy store by the module connector, whereby the aforementioned circuit is closed, for example. Thus, the first line element is designed, for example, to carry the electrical energy stored in the storage cells or in the electrical energy store.

The electrical energy store also has at least one second line element, which is formed separately from the first line element. It is conceivable that the second line element is arranged in the circuit, or the second line element is arranged outside the circuit. For example, the second line element is designed to transfer the electrical energy stored in the storage cells. Furthermore, it is conceivable that the second line element is designed to transfer at least one electrical signal. The electrical signal characterizes, for example, an electrical voltage of at least one of the storage cells and/or a temperature of at least one of the storage cells. Furthermore, it is conceivable that the second line element has at least or exactly one channel, which is preferably directly bounded by the second line element, in particular directly by a sheath surface of the second line element on the inner circumference. For example, a fluid can flow through the channel, which can, for example, directly contact the second line element or the inner circumferential sheath surface on its way through the channel. In particular, the fluid is a tempering agent for temperature control, i.e. for cooling and/or heating at least part of the electrical energy store. Most preferably, the fluid is a liquid which, for example, can be formed at least partially, especially at least predominantly and thus at least more than half, by water. Thus, the second line element is used, for example, to guide or conduct the fluid.

In order to be able to realize a particularly simple and thus time-and cost-effective production of the electrical energy store, it is provided according to the invention that the first line element is connected to the second line element by at least one connecting element formed separately from the line elements, which is also referred to as the first connecting element. The first connecting element is interlocked with the second line element and is thus attached to the second line element, and thus connected to the second line element. Thus, the first line element is connected to the second line element by the first connecting element, and is therefore held on the second line element. As a result, the line elements are or form a single unit, which can also include the first connecting element, for example. The component can be pre-assembled, in particular independently of the rest of the electrical energy store, and can be handled and installed in its pre-assembled state, in particular as a whole, for example in a housing of the electrical energy store, also known as a store housing, in the housing of which the modules are arranged, for example. Since the unit can be pre-assembled on its own and handled and installed in its pre-assembled state, the energy store can be manufactured in a time-and cost-effective manner, especially if the line elements have a long length and/or a complex course. For example, the unit is or forms a cable harness or a line harness which can be installed in a time-effective and cost-effective manner, especially because the line elements are connected to each other by the first connecting element and thus held together.

In order to be able to connect the first connecting element to the second line element in a particularly simple and thus time-and cost-effective manner and thus to be able to manufacture the electrical energy store in a particularly time-and cost-effective manner, it is envisaged in one embodiment of the invention that the connecting element is locked to the second line element and is thereby attached to the second line element.

The feature whereby the first connecting element is interlocked with the second line element, whereby the first connecting element is connected to the second line element, is to be understood in particular as meaning that, for example, at least a first part of the first connecting element, in particular at least a first wall area, of the first connecting element encompasses and/or grips at least a second part of the line, in particular at least a second wall area, of the second line element and/or and thus interacts with the second part in a form-fitting manner, whereby the first connecting element interacts in a form-fitting manner with the second line element and is thus attached to the second line element. In particular, the first connecting element forms at least one interlocking arrangement with the second line element, in which, for example, as described above, the first part encompasses and/or grips the second part. The interlocking arrangement can be a micro-interlocking arrangement, for example. This is to be understood in particular as meaning that, for example, the first connecting element is arranged in particularly direct supporting contact with a wall of the second line element that appears smooth to the human eye, for example, wherein, for example, the first connecting element is held in particularly direct supporting contact with the smooth wall by a spring force acting in particular in the first connecting element. Even if the wall appears smooth to the human eye and therefore has no unevenness to the human eye, the wall has, for example, microscopic unevenness, with which the first connecting element forms at least one hook, for example because the first connecting element is attached to the wall. As a result, the first connecting element is interlocked with the second line element and is thus attached to the second line element. The aforementioned spring force is, for example, caused by the first connecting element being elastically deformed, in particular because it interacts with the second line element. As a result, the aforementioned spring force acts as an internal force in the first connecting element, whereby the interlocking of the first connecting element with the second line element is advantageously formed. For example, the first connector interacts with the second connector in particular by the fact that, for example, the first connecting element is attached to the second line element. Alternatively or additionally, for example, the first connecting element forms a snap-on connection with the second line element, whereby the first connecting element is connected to the second line element, i.e. attached to the second line element. When the first connecting element is connected to the second line element, for example, the first connecting element is at least partially elastically deformed, thereby transferring from an initial state to a first elastically deformed state of the first connecting element, for example. In the finished or completely connected state of the first connecting element to the second line element, the first connecting element is, for example, in the first deformation state, whereby the first connecting element is elastically deformed and, for example, interlocked with the second line element. For example, in the first deformation state, the aforementioned spring force acts in the first connecting element. Furthermore, it is conceivable that, as the connection of the first connecting element with the second conduction element progresses, the first connecting element, after it has been brought into the first elastically deformed state, may relax at least partially or only partially or completely, whereby the first connecting element is transferred from the first elastically deformed state to a connecting state. In the connecting state, for example, the first connecting element is completely relaxed, or in the connecting state the first connecting element is still elastically deformed, but less strongly than in the first elastically deformed state. Thus, for example, the connecting state is a second elastically deformed state of the first connecting element. In the connecting state, the first connecting element interacts with the second line element, in particular in a form-fitting manner, whereby the first connecting element is attached to the second line element. For example, in the connecting state, the first connecting element interacts with the second line element in such a way that the first connecting element is interlocked with the second line element, in particular in the manner described above. Thus, for example, the first fastener is a snap-on fastener and/or a latching element which, for example, is locked to the second line element and is thus connected to the second line element, in particular in a form-fitting manner.

For example, the first connecting element is connected to, in particular locked to, the second line element in such a way, in particular in a form-fitting manner, that, for example, at least one first locking lug of the first connecting element encompasses and/or grips at least a second locking lug of the second line element. This means that the first connecting element is attached to the second line element. The first connecting element is also known as clips or connecting clips. For example, the first connecting element is connected to the second line element by at least or exactly one connector, which includes, for example, that the first connecting element and the second line element are plugged into each other. Here, for example, the first connecting element is attached to the second line element. Because the first connecting element is interlocked with the second line element and is thus connected, the first connector is clipped to the second line element, so that the first connecting element is also referred to as clips or connecting clips.

In order to be able to connect the connecting element to the second line element in a particularly simple and thus time-and cost-effective manner, it is provided in a further embodiment of the invention that the first connecting element is attached to a part of the second line element and is interlocked with the part of the second line element. In particular, it is conceivable that the part of the second line element is or contains the aforementioned wall of the second line element.

It has been shown to be particularly advantageous if the part of the second line element is a rib of the second line element that protrudes, for example, from at least one area of the second line element adjacent to the rib. The rib itself ends, for example, at a free end of the rib, at which, for example, an edge, especially an end edge, of the rib is provided or formed. Since the first connecting element is preferably attached to the rib and thus to the edge, the first connecting element is preferably in the form of an edge clips. The edge clips is also referred to as an edge clip and can be attached to the second line element in a particularly simple and thus time-and cost-effective way, in such a way that the edge clip is attached to the rib and thereby to the edge.

Another embodiment is characterized in that the part of the second line element is made of plastic. This allows a particularly advantageous geometry of the part of the second line element to be realized in a particularly cost-effective way, in order to be able to connect the first connecting element to the part of the second line element easily and thus in a time-and cost-effective manner.

In another, particularly advantageous embodiment of the invention, the part of the second line element is formed by injection molding, in particular by plastic injection molding, whereby the part of the second line element can be produced particularly quickly and cost-effectively.

In a further, particularly advantageous embodiment of the invention, a second connecting element is provided which is formed separately from the line elements and separately from the first connecting element, and by which the first line element is connected to the first connecting element, and thus is held on the first connecting element. This makes it possible to implement a particularly simple and thus particularly time-and cost-effective holding of the first line element against the second line element by the connecting elements.

In order to be able to hold the first line element particularly easily by the second connecting element against the first connecting element and by this against the second line element, it is envisaged in a further embodiment of the invention that the second connecting element is in the form of a cable tie.

Finally, it has been shown to be particularly advantageous if the electrical energy store has a shaft element, which is also known as a cable duct and which is formed separately from the line elements and separately from the first connecting element, and preferably separately from the second connecting element. The shaft element has at least or exactly one cable duct in which the first line element and/or the second line element run at least partially and are thereby guided.

Most preferably, it is provided that the first line element is held on the shaft element by a third connecting element that is formed separately from the line elements and separately from the shaft element and separately from the first connecting element and separately from the second connecting element, and is thus connected to the shaft element, wherein, for example, the previous and following comments about the first connecting element can also be simply transferred to the second connecting element and vice versa. Furthermore, it is conceivable that, for example, the first line element is connected to the third line element by a fourth connecting element, wherein the fourth connecting element is formed separately from the line elements, separately from the shaft element, separately from the first connecting element, separately from the second connecting element and separately from the third connecting element. For example, the previous and following comments about the second connecting element can simply be transferred to the fourth connecting element and vice versa. As a result, a particularly simple, time-effective and cost-effective installation of the line elements can be described.

A second aspect of the invention relates to a motor vehicle simply also referred to as a vehicle and preferably in the form of a car, in particular a passenger car, which has an electrical energy store according to the first aspect of the invention. Advantages and advantageous embodiments of the first aspect of the invention are to be regarded as advantages and advantageous embodiments of the second aspect of the invention and vice versa.

The invention is based in particular on the following findings and considerations: In conventional energy stores, lines such as cables and/or fluid-carrying lines are routed in a limited installation space, usually shafts and shaft elements. This makes it possible to determine a route of the respective line in a needs-based and targeted manner. In the shafts, the lines are usually held down with the help of hinges. However, the conventional solutions were complex and therefore could only be produced in a time-consuming and cost-intensive manner. In contrast, the invention now makes it possible to assemble the line elements in a simple and thus time-and cost-effective way and, for example, to attach them to the aforementioned store housing. Particularly in the fully manufactured state of the electrical energy store, for example, the second line element is a component surrounding the first line element, to which the first line element is attached in a timely and cost-effective manner. The invention also enables a particularly advantageous tolerance compensation, in particular by an appropriate design of a length of the mentioned edge or rib, to which preferably the first connecting element is applied, that is attached. In addition, an application sequence can be defined, for example, to ensure that all ribs along a course of the respective line element coincide with the respective positions of the first connecting elements. Another advantage of the rib is that an advantageously high stiffness can be realized.

It is conceivable that the third connecting element is in the form of a further edge clips, which, for example, is attached to a corresponding further rib of the shaft element and thus to a further corresponding edge of the further rib, which is in the form in particular of an end edge, and thus of the shaft element. This allows an advantageously high stiffness of the shaft element to be embodied. It is advantageous to choose a sufficiently large distance between the first connecting elements or between the ribs to ensure an advantageous tolerance compensation between the ribs on different components. For this purpose, corresponding tolerance calculations and limit pattern tests can be carried out. If, for example, several first connecting elements and thus, for example, several corresponding ribs are used to hold the first line element against the second line element, a secure and advantageous holding of the first line element against the second line element can be ensured even if some of the first connecting elements are not mounted as part of an assembly. The invention thus enables a secure and robust, i.e. fault-tolerant, holding of the first line element against the second line element.

Further advantages, features and details of the invention can be found in the following exemplary embodiment with the associated drawings.

### BRIEF DESCRIPTION OF THE DRAWINGS

FIG. 1 shows a partial schematic perspective view of part of an electrical energy store for a motor vehicle;

FIG. 2 shows a partial schematic view of a connection arrangement of a first line element to a second line element of the energy store;

FIG. 3 shows a partial schematic perspective view of a connection arrangement of the first line element to a shaft element of the electrical energy store; and

FIG. 4 shows a schematic side view of the connection arrangement according to FIG. 3.

In the figs. identical or functionally identical elements are provided with the same reference signs.

### DETAILED DESCRIPTION OF THE DRAWINGS

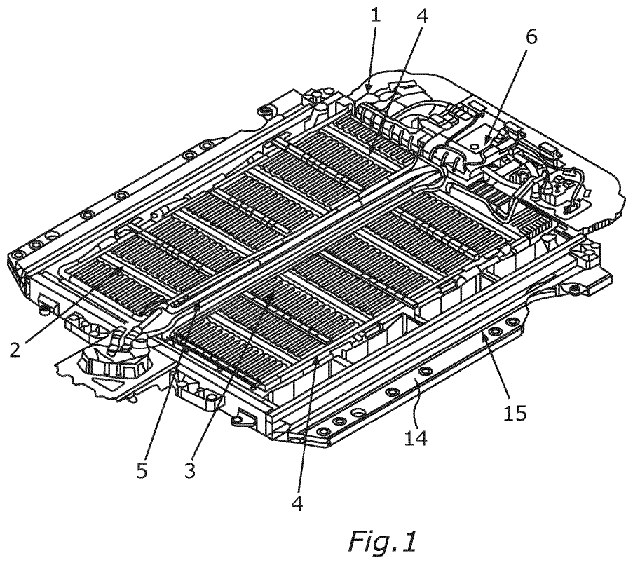

FIG. 1 shows a partial schematic perspective view of an electrical energy store 1 for a motor vehicle simply also referred to as a vehicle. The electrical energy store 1 is a high-voltage component, the electrical voltage of which, in particular the electrical operating voltage or nominal voltage, is preferably greater than 50 volts, in particular greater than 60 volts, and is most preferably several 100 volts. For this reason, the electrical energy store 1 is also referred to as a high-voltage store (HVS).

The electrical energy store 1 has at least two storage modules 2 and 3, wherein the respective storage module 2, 3 has several storage cells 4 for the storage of electrical energy, in particular electrochemically. The storage cells 4 of the respective storage modules 2, 3 are electrically connected to each other, and the storage modules 2 and 3, also known simply as modules, are electrically connected to each other. For this purpose, the storage modules 2 and 3 are presented in a circuit not shown in detail in the fig., by which the storage modules 2 and 3 are electrically connected to each other. From FIG. 1 it can be seen that the circuit has at least one first line element 5, which is thus arranged in the circuit. The first line element 5 is also referred to as a module connector because the storage modules 2 and 3 are electrically connected to each other via the line element 5. In other words, for example, the circuit is closed by the line element 5.

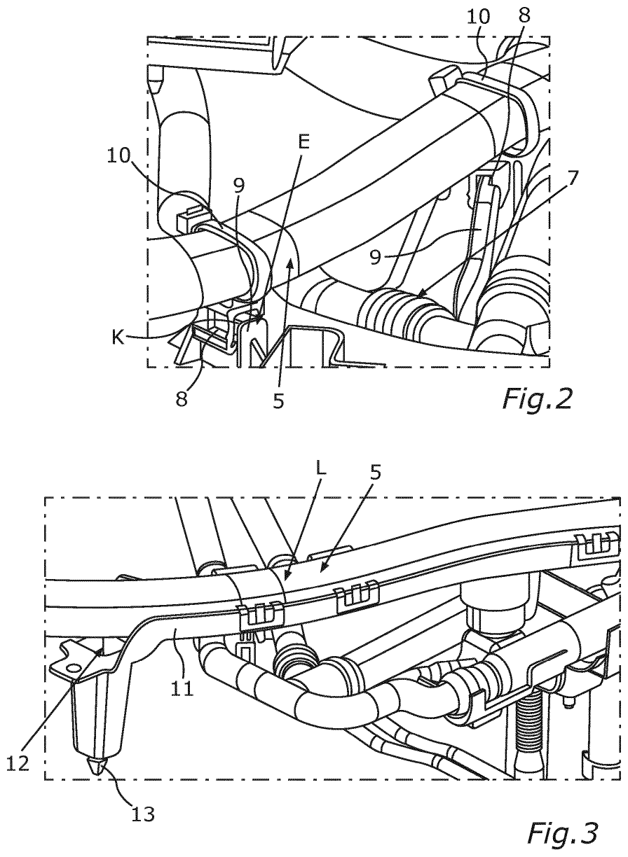

The electrical energy store 1 also has at least one battery management unit 6, wherein, for example, one of the storage modules 2, 3 is electrically connected to the battery management unit 6 by the module connector. In conjunction with FIG. 2, it can be seen that the electrical energy store 1 also has at least one second line element 7 which is provided in addition to the first line element 5 and which is formed separately from the line element 5. For example, by the first line element 5, the electrical energy stored in the storage cells 4 can be conducted and transferred, for example to an electrical machine of the motor vehicle, which can be electrically driven by the electric machine, especially solely. For example, the electrical energy stored in the storage cells 4 can be transferred by the second line element 7, or at least an electrical signal can be transmitted by the line element 7, for example to the battery management unit 6, wherein the signal characterizes, that is indicates or describes, for example, at least a temperature of at least one of the storage cells 4 and/or at least an electrical voltage of at least one of the storage cells 4. Alternatively, it is conceivable that the second line element 7 is a fluid-carrying line which, for example, has at least or exactly one channel that can carry a flow of a liquid fluid, for example. For example, the fluid can be used to vary the temperature, i.e. to cool and/or heat at least part of the electrical energy store 1. The line elements 5 and 7 are formed separately from each other, so that the line elements 5 and 7 are not formed in one piece with each other. In other words, the line elements 5 and 7 are not formed in one piece, but the line elements 5 and 7 are separately formed components.

In order to be able to produce the electrical energy store 1 in a timely and cost-effective manner and, in particular, to compensate for tolerances in an advantageous manner, it is provided for the electrical energy store 1 that the first line element 5 is connected to the second line element 7 by several connecting elements 8 formed separately from the line elements 5 and 7 and formed separately from each other. The respective connecting element 8 is a respective clip, which is also referred to as clips. The respective connecting element 8 is interlocked with the second line element 7 and thus held on the second line element 7. In the exemplary embodiment shown in FIG. 2, the respective connecting element 8 is locked to the second line element 7 and thus interlocked with the second line element 7 and thus attached to the second line element 7. In the exemplary embodiment shown in the fig., the respective connecting element 8 is an edge clip, which is also referred to as edge clips. For each connecting element 8, the line element 7 has a part in the form of a rib 9 of the line element 7, which ends at a respective free end E of the respective part, thus the respective rib 9. At the respective free end E of the respective rib 9, the respective rib 9 has an edge K, also referred to as the end edge, wherein in the present case the respective connecting element 8, which is in the form of an edge clip, is attached to the respective associated rib 9 and thus to the corresponding edge K. For example, the respective connecting element 8 has at least one first locking lug, which, for example, grips a respective corresponding second locking lug of the corresponding rib 9, in particular in relation to an attachment direction in which the respective connecting element 8 is attached to the respective rib 9. Since the respective first locking lug grips the respective second locking lug, the respective connecting element 8 works together with the respective associated rib 9 and thus with the second line element 7 in a form-fitting manner, whereby the respective connecting element 8 interlocks with the respective corresponding rib 9 and is thus attached to the respective rib 9.

The respective rib 9 is made, i.e. formed, by plastic injection molding and is thus molded from plastic, so that the respective rib 9 is made of a plastic. Most preferably, the ribs 9 are formed together in a single layer, i.e. formed from a single piece and produced by the aforementioned plastic injection molding. The respective connecting element 8 and the associated rib 9 form a respective connecting element pair. For example, a second connecting element 10 is provided for each pair of connecting elements, which is formed separately from the line elements 5 and 7 and separately from the connecting element 8. In addition, the connecting elements 10 are formed separately from each other.

In the exemplary embodiment shown in FIG. 2, the respective connecting element 10 is a respective cable tie. It can be seen particularly well from FIG. 2 that the respective first line element 5 is connected to the respective first connecting element 8 by the respective second connecting element 10. As a result, for example, respective parts of the respective second connecting element 10 are connected to each other, in particular in a form-fitting manner, in particular are locked together and thus connected to each other. As a result, for example, the respective connecting element 10 forms a respective loop, i.e. a respective loop with a respective through opening, wherein the first line element 5 passes though the respective loop. In addition, for example, the respective second connecting element 10 passes through at least one corresponding through opening of the respective connecting element 8, wherein the respective connecting element 10 is held on the respective connecting element 8 in a form-fitting manner. Thus, the line element 5 is held on the respective connecting element 10 in a form-fitting manner, and the line element 5 is held by the respective connecting element 10 in a form-fitting manner on the respective connecting element 8, which, however, is attached to the respective rib 9. Thus, FIG. 2 shows a first connection arrangement of the line element 5 to the line element 7. With the first connection arrangement, the line element 5 is held on the ribs 9 of the line element 7 and thus on the line element 7 by the connecting elements 8 and 10.

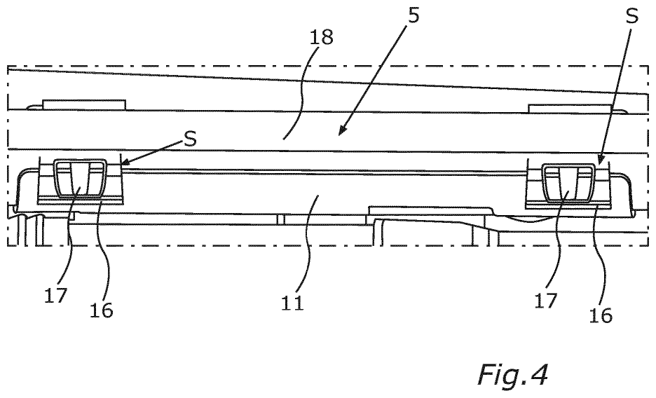

FIGS. 3 and 4 show a second connection arrangement of the first line element 5 to a corresponding shaft element 11. The shaft element 11 is formed separately from the line elements 5 and 7 and separately from the connecting elements 8 and 10. It can be seen that the shaft element 11 has a shaft 12, also referred to as a line shaft or cable duct, in which at least a length region L of the line element 5 runs and is thus guided, i.e. is arranged. For example, the shaft element 11 is made of plastic and/or by injection molding. In particular, the shaft element 11 is formed in one piece, i.e. is formed from a single piece. The shaft element 11, for example, has another connecting element 13, by which, for example, the shaft element 11 is attached to a housing element 14 that can be seen from FIG. 1 of a housing 15 of the electrical energy store 1, also known as a store housing. The storage modules 2 and 3 and also the line elements 5 and 7 are arranged in the housing 15.

It can be seen particularly well from FIG. 4 that the first line element 5 is locked, in particular directly, to the shaft element 11 and is thus attached to the shaft element 11. For this purpose, for example, at least one locking lug 16 encompasses or grips at least or exactly one corresponding locking lug 17, wherein the locking lug 16 is a locking lug of the line element 5 and the locking lug 17 is a locking lug of the shaft element 11. In particular, for example, the locking lug 16 is pivotably held by a film hinge S on a base body 18 of the line element 5, wherein the base body 18 and the locking lug 16 are formed together in one piece, i.e. formed from a single piece. For example, the line element 5 can be inserted in the corresponding shaft 12 and thus in the shaft element 11. As a result, for example, the locking lug 16 can be folded relative to the base body 18 and relative to the locking lug 17 in such a way that the locking lug 16 grips the locking lug 17, i.e. it is locked to the locking lug 17. As a result, the line element 5 is securely fastened in the shaft 12 and to the shaft element 11.

For example, the connecting element 13 of the shaft element 11, which is in the form of a locking element and, for example, which is locked to the housing element 14 and thus connected to the housing element 14, is for example locked to a corresponding locking element, in particular of the housing element 14, which means that the shaft element 11 can be easily and firmly attached to the housing element 14.

In particular, it is conceivable to connect the shaft element 11 to the line element 5 before the shaft element 11 is connected to the housing element 14 and, in particular, it is conceivable that the connecting element 8 is connected to the line element 5 by the connecting element 10 before the connecting element 8 is attached to the respective rib 9. Then, for example, the respective connecting element 8 is attached to the respective corresponding rib 9, whereby the line elements 5 and 7 are connected to each other easily and thus in a time-and cost-effective manner. As a result, the line elements 5 and 7 form a unit that is assembled independently of the rest of the energy store 1 and thus pre-assembled, which is, for example, a cable harness. The unit can then be easily handled, especially as a whole, and thus installed in a time-and cost-effective manner, in particular on the housing element 14. For example, the component is mounted on the housing element 14, in particular attached to the housing element 14, by attaching the shaft element 11 to the housing element 14 by the connecting element 13. As a result, a particularly time-and cost-effective production of the electrical energy store 1 can be demonstrated.

In addition, tolerances can be compensated for particularly advantageously. For this purpose, for example, a respective length of the respective edge K or the respective rib 9 is designed in such a way that tolerances can be offset, i.e. can be compensated, in a particularly advantageous way.

### LIST OF REFERENCE SIGNS

1 Electrical energy store
2 Storage module
3 Storage module
4 Storage cells
5 First line element
6 Battery management unit
7 Second line element
8 First connecting element
9 Rib
10 Second connecting element
11 Shaft element
12 Shaft
13 Connecting element
14 Housing element
15 Housing
16 Locking lug
17 Locking lug
18 Base body
E Free end
K Edge
L Length region
S Film hinge

1-10. (canceled)

11. An electrical energy store for a motor vehicle, comprising:
at least two storage modules, each containing several electrically connected storage cells configured to store electrical energy and arranged in a circuit comprising:
at least one first line element, by which the at least two storage modules are electrically connected to each other; and
at least one second line element formed separately from the first line element,
wherein the first line element is connected to the second line element by at least one first connecting element formed separately from the line elements, which is interlocked with the second line element and is thus attached to the second line element.

12. The electrical energy store according to claim 11,
wherein the at least one first connecting element is locked to the second line element and is thereby attached to the second line element.

13. The electrical energy store according to claim 11,
wherein the at least one first connecting element is attached to a part of the second line element and interlocked with the part of the second line element.

14. The electrical energy store according to claim 13,
wherein the part of the second line element is a rib of the second line element.

15. The electrical energy store according to claim 13,
wherein the part of the second line element is made of plastic.

16. The electrical energy store according to claim 13,
wherein the part of the second line element is formed by injection molding.

17. The electrical energy store according to claim 11, comprising:
a second connecting element formed separately from the line elements and separately from the at least one first connecting element, by which the first line element is connected to the at least one first connecting element.

18. The electrical energy store according to claim 17,
wherein the second connecting element is in a form of a cable tie.

19. The electrical energy store according to claim 11, comprising:
a shaft element formed separately from the line elements and separately from the at least one first connecting element, which has a line shaft in which the first line element and/or the second line element runs at least partially.

20. A motor vehicle comprising:
the electrical energy store according to claim 11.
